(19) United States
(12) Patent Application Publication
(10) Pub. No.: US 2012/0252705 A1
(43) Pub. Date: Oct. 4, 2012

(54) Treatment Fluids Comprising Vitrified Shale and Methods of Using Such Fluids in Subterranean Formations

(75) Inventors: Girish Dinkar Sarap, Pune (IN); Christopher L. Gordon, Oklahoma City, OK (US); Manoj Sivanandon, Pune (IN); Trissa Joseph, Pune (IN)

(73) Assignee: Halliburton Energy Services, Inc., Houston, TX (US)

(21) Appl. No.: 13/494,558

(22) Filed: Jun. 12, 2012

Related U.S. Application Data
(62) Division of application No. 12/836,309, filed on Jul. 14, 2010.
Application No. 12/836,309 is a continuation-in-part of application No. 11/844,188, filed on Aug. 23, 2007, now abandoned.
Application No. 11/844,188 is a division of application No. 10/969,570, filed on Oct. 20, 2004, now Pat. No. 7,293,609.

(51) Int. Cl. C09K 8/40

(52) U.S. Cl. 507/108; 507/236; 507/235; 507/128; 507/207; 507/244; 507/131; 507/103; 507/260

(57) ABSTRACT

Non-settable spacer fluids for use in subterranean operations comprising: a base liquid; vitrified shale; a chelating agent; a clay weighting agent; and a viscosifying agent. The chelating agent includes one or more of nitrilotriacetic acid, ethylene diamine tetracetic acid (EDTA), ethylene glycol tetraacetic acid (EGTA), tartaric acid, a polycarboxylic acid, a lignosulphonate, hydroxyethylidene diphoshponic acid (HEDP), diethylene triamine penta (methylene phosphonic) acid (DETMP), amino-tri-methylene phosphonic acid (ATMP), ethylene diamine tetra (methylene phosphonic) acid (EDTMP), or salts thereof. The clay weighting agent is present in the range of about 0.01% to about 85% by weight of the spacer fluid. The viscosifying agent is present in the range of about 1% to about 10% by weight of the spacer fluid.

### CROSS REFERENCE TO RELATED APPLICATIONS

The present invention is a continuation-in-part of U.S. application Ser. No. 11/844,188 entitled “Treatment Fluids Comprising Vitrified Shale and Methods of Using Such Fluids in Subterranean Formations,” filed Aug. 23, 2007 and published as 2007/0284103, which is a division of U.S. application Ser. No. 10/969,570 entitled “Treatment Fluids Comprising Vitrified Shale and Methods of Using Such Fluids in Subterranean Formations,” filed Oct. 20, 2004 and published as 2006/0081372, which are hereby incorporated by reference.

### BACKGROUND

The present invention relates to subterranean treatment operations, and more particularly, to improved spacer fluids comprising vitrified shale, and methods of using these improved spacer fluids in subterranean formations.

Treatment fluids are used in a variety of operations that may be performed in subterranean formations. As referred to herein, the term “treatment fluid” will be understood to mean any fluid that may be used in a subterranean application in conjunction with a desired function and/or for a desired purpose. The term “treatment fluid” does not imply any particular action by the fluid. Treatment fluids often are used in, e.g., well drilling, completion, and stimulation operations. Examples of such treatment fluids include drilling fluids, well cleanup fluids, workover fluids, conformance fluids, gravel pack fluids, acidizing fluids, fracturing fluids, spacer fluids, and the like.

Spacer fluids often are used in oil, gas, and geothermal wells to facilitate improved displacement efficiency when displacing multiple fluids into a wellbore. For example, spacer fluids often may be placed within a subterranean formation so as to physically separate incompatible fluids. Spacer fluids also may be placed between different drilling fluids during drilling-fluid changeouts, or between a drilling fluid and a completion brine.

Spacer fluids also may be used in primary cementing operations to separate a drilling fluid from a cement composition that may be placed in an annulus between a casing string and the subterranean formation, whether the cement composition is placed in the annulus in either the conventional or reverse-circulation direction. The cement composition often is intended to set in the annulus, supporting and positioning the casing string, and bonding to both the casing string and the formation so as to form a substantially impermeable barrier, or cement sheath, which facilitates zone isolation. However, if the spacer fluid does not adequately displace the drilling fluid from the annulus, the cement composition may fail to satisfactorily bond to the casing string and/or the formation. In certain circumstances, spacer fluids also may be placed in subterranean formations to ensure that all down hole surfaces are water-wetted, or that drilling fluids are completely removed, before the subsequent placement of a cement composition, which may enhance the bonding that occurs between the cement composition and the water-wetted surfaces.

Conventional spacer fluids often comprise materials that are costly and that may become unstable at elevated temperatures, a particularly undesirable problem in high-pressure, high-temperature (HPHT) wells. For example, at temperatures above about 300° F., many common polymers and/or biopolymers used as viscosifiers experience degradation and thus may prematurely reduce the viscosity of the fluid. Such failure may cause the fluid to lose the capacity to holding weighting materials or may prevent the fluid from lifting and/or displacing the drilling fluid, resulting in poor integrity in the bond between the cement and the formation.

### SUMMARY OF THE INVENTION

The present invention relates to subterranean treatment operations, and more particularly, to improved treatment fluids comprising vitrified shale, and methods of using these improved treatment fluids in subterranean formations.

In an embodiment, a method of displacing a fluid in a wellbore comprises: providing a wellbore having a first fluid disposed therein; and placing a second fluid into the wellbore to at least partially displace the first fluid therefrom; wherein the second fluid comprises a base liquid; vitrified shale; a clay weighting agent present in the range of about 5% to about 20% by weight of the second fluid; and a viscosifying agent present in the range of about 1% to about 10% by weight of the second fluid.

In another embodiment, a method of separating fluids in a wellbore, comprises: providing a wellbore having a first fluid disposed therein; placing a spacer fluid in the wellbore to separate the first fluid from a second fluid; wherein the spacer fluid comprises a base liquid; vitrified shale; a clay weighting agent present in the range of about 5% to about 20% by weight of the spacer fluid; and a viscosifying agent present in the range of about 1% to about 10% by weight of the spacer fluid.

In still another embodiment, a spacer fluid comprises: a base liquid; vitrified shale; a clay weighting agent present in the range of about 5% to about 20% by weight of the spacer fluid; and a viscosifying agent present in the range of about 1% to about 10% by weight of the spacer fluid; wherein the spacer fluid is not settable.

The features and advantages of the present invention will be readily apparent to those skilled in the art upon a reading of the description of the preferred embodiments that follows.

### BRIEF DESCRIPTION OF THE DRAWINGS

FIG. 1A is a plot illustrating compatibility of a particular embodiment of the present invention, rounding up shear rate.

FIG. 1B is a plot illustrating compatibility of the embodiment of FIG. 1A, rounding down shear rate.

FIG. 2A is a plot illustrating compatibility of another embodiment of the present invention, rounding up shear rate.

FIG. 2B is a plot illustrating compatibility of the embodiment of FIG. 2A, rounding down shear rate.

FIG. 3 is a compatibility graph.

### DETAILED DESCRIPTION

The present invention relates to subterranean treatment operations, and more particularly, to improved treatment fluids comprising vitrified shale, and methods of using these improved treatment fluids in subterranean formations. The treatment fluids of the present invention are suitable for use in a variety of subterranean treatment applications, including well drilling, completion, and stimulation operations.

The treatment fluids of the present invention generally comprise vitrified shale and a base fluid (e.g., a base liquid), and are not settable. Optionally, the treatment fluids of the present invention may comprise additional additives as may be required or beneficial for a particular use. For example, the treatment fluids of the present invention may include synthetic magnesium silicates, viscosifying agents, organic polymers, dispersants, surfactants, weighting agents, salts, and the like.

The vitrified shale used in the treatment fluids of the present invention generally comprises any partially vitrified silica-rich material. Vitrified shale includes any fine-grained rock formed by the consolidation of clay or mud that has been at least partially converted into a crystalline, glassy material. In certain embodiments of the present invention, the vitrified shale has a percent volume oxide content, as determined by quantitative x-ray diffraction, as set forth in Table 1 below.

TABLE 1

| Oxide | Volume % |
|---|---|
| SiO₂ | 57-73 |
| Al₂O₃ | 15-25 |
| Fe₂O₃ | 3-7 |
| CaO | 2-6 |
| K₂O | 1-5 |
| SO₃ | 1-3 |
| MnO, SrO, TiO₂, BaO, and Na₂O | each <1% |

An example of a suitable vitrified shale is commercially available under the trade name “PRESSUR-SEAL® FINE LCM” from TXI Energy Services, Inc., of Houston, Tex. In certain embodiments of the present invention, the vitrified shale may be stable up to 1000° F. In certain embodiments of the present invention, the vitrified shale is present in the treatment fluids of the present invention from about 0.01% to about 90% by weight of the treatment fluid. In other embodiments of the present invention, the vitrified shale is present in the treatment fluids of the present invention from about 1% to about 20% by weight of the treatment fluid. In other embodiments of the present invention, the vitrified shale is present in the treatment fluids of the present invention from about 1% to about 10% by weight of the treatment fluid. One skilled in the art, with the benefit of this disclosure, will recognize a suitable amount of vitrified shale for a particular application.

The base fluid used in the treatment fluids of the present invention may comprise an aqueous-based fluid, an oil-based fluid, a synthetic fluid, or an emulsion. In certain embodiments of the present invention, the base fluid may be an aqueous-based fluid that comprises fresh water, salt water, brine, sea water, or a mixture thereof. In certain embodiments of the present invention, the base fluid may be an aqueous-based fluid that may comprise cesium and/or potassium formate. The base fluid can be from any source provided that it does not contain compounds that may adversely affect other components in the treatment fluid. The base fluid may be from a natural or synthetic source. In certain embodiments of the present invention, the base fluid may comprise a synthetic fluid such as, but not limited to, esters, ethers, and olefins. Generally, the base fluid will be present in the treatment fluids of the present invention in an amount sufficient to form a pumpable slurry. In certain embodiments, the base fluid will be present in the treatment fluids of the present invention from about 15% to about 95% by weight of the treatment fluid. In other embodiments, the base fluid will be present in the treatment fluids of the present invention from about 25% to about 85% by weight of the treatment fluid. One of ordinary skill in the art, with the benefit of this disclosure, will recognize the appropriate amount of base fluid to use for a chosen application.

Optionally, the treatment fluids of the present invention further may comprise a viscosifying agent. The viscosifying agent may be any component suitable for providing a desired degree of solids suspension. The choice of a viscosifying agent depends upon factors such as the desired viscosity and the desired chemical compatibility with other fluids (e.g., drilling fluids, cement compositions, and the like). In certain embodiments of the present invention, the viscosifying agent may be easily flocculated and filtered out of the treatment fluids of the present invention. Suitable viscosifying agents may include, but are not limited to, colloidal agents (e.g., clays, polymers, guar gum), emulsion forming agents, diatomaceous earth, starches, biopolymers, synthetic polymers, or mixtures thereof. Suitable viscosifying agents often are hydratable polymers that have one or more functional groups. These functional groups may include, but are not limited to, hydroxyl groups, carboxyl groups, carboxylic acids, derivatives of carboxylic acids, sulfate groups, sulfonate groups, phosphate groups, phosphonate groups, and amino groups. In certain embodiments of the present invention, viscosifying agents may be used that comprise hydroxyl groups and/or amino groups. In certain embodiments of the present invention, the viscosifying agents may be biopolymers, and derivatives thereof, that have one or more of these monosaccharide units: galactose, mannose, glucoside, glucose, xylose, arabinose, fructose, glucuronic acid, or pyranosyl sulfate. Examples of suitable biopolymers include, but are not limited to, guar gum and derivatives thereof, such as hydroxypropyl guar and carboxymethyl hydroxypropyl guar, and cellulose derivatives, such as hydroxyethyl cellulose, welan gums, and xanthan gums. Additionally, synthetic polymers that contain the above-mentioned functional groups may be used. Examples of such synthetic polymers include, but are not limited to, poly(acrylate), poly(methacrylate), poly(ethylene imine), poly(acrylamide), poly(vinyl alcohol), and poly(vinylpyrrolidone). Other suitable viscosifying agents include chitosans, starches and gelatins. Suitable clays include kaolinites, montmorillonite, bentonite, hydrous micas, attapulgite, sepiolite, and the like, as well as naturally occurring clays, and synthetic clays, such as laponite. An example of a suitable viscosifying agent is a hydroxyethyl cellulose that is commercially available under the trade name “WG-17” from Halliburton Energy Services, Inc., of Duncan, Okla. Another example of a suitable viscosifying agent is a welan gum that is commercially available under the trade name “BIOZAN” from Kelco Oilfield Services, Inc. Another preferred viscosifying agent may be bentonite.

In certain embodiments of the present invention, the viscosifying agent may include a high temperature synthetic inorganic magnesium silicate viscosifier material, commercially available under the trade name “THERMA VIS™” from Bariod Fluid Systems of Houston, Tex., and having thermal stability up to 700° F. Such a high temperature inorganic viscosifier material may fall under the class of hectorite clays, such as a synthetic magnesium silicate (e.g., lithium magnesium sodium silicate), or may be other similar products such as Laponite RD from Rockwood, bentonite (commercially available under the trade name “AQUAGEL GOLD SEAL®” from Bariod Fluid Systems of Houston, Tex.), vitrified shale, or metakaolin. In certain embodiments, the viscosifying agent may include an amorphous/fibrous material used to impart viscosity and suspension properties to oil-based drilling fluids, and which may yield more readily with shear when fluid temperatures are at least 120° F., (e.g., “TAU MOD™” commercially available from Halliburton Energy Services, Inc., of Duncan, Okla.).

Where included, the viscosifying agent may be present in the treatment fluids of the present invention in an amount sufficient to provide a desired degree of solids suspension. In certain embodiments, the viscosifying agent may be present from about 0.01% to about 35% by weight of the treatment fluid. In other embodiments, the viscosifying agent may be present from about 5% to about 20% by weight of the treatment fluid. In other embodiments, the viscosifying agent may be present from about 1% to about 10% by weight of the treatment fluid. In other embodiments, the viscosifying agent may be present from about 0.5% to about 2% by weight of the treatment fluid. In certain embodiments of the present invention wherein the treatment fluids will be exposed to elevated pH conditions (e.g., when the treatment fluids will be contacted with cement compositions), viscosifying agents such as welan gum, cellulose (and cellulose derivatives), and xanthan gum may be particularly suitable. One of ordinary skill in the art, with the benefit of this disclosure, will be able to identify a suitable viscosifying agent, as well as the appropriate amount to include, for a particular application.

Optionally, the treatment fluids of the present invention further may comprise a fluid loss control additive (hereinafter “FLCA”). Any FLCA suitable for use in a subterranean application may be suitable for use in the compositions and methods of the present invention. In certain embodiments, the FLCA may comprise organic polymers, starches, or fine silica. An example of a fine silica that may be suitable is commercially available from Halliburton Energy Services, Inc. under the trade name “WAC-9.” An example of a starch that may be suitable is commercially available from Halliburton Energy Services, Inc. under the trade name “DEXTRID.” In certain embodiments where the treatment fluids of the present invention comprise a FLCA, the FLCA may be present in the treatment fluids of the present invention from about 0.01% to about 6% by weight of the treatment fluid. In other embodiments, the FLCA may be present in the treatment fluids of the present invention from about 0.05% to about 0.1% by weight of the treatment fluid. One skilled in the art, with the benefit of this disclosure, will recognize the appropriate amount of a FLCA to use for a particular application.

Optionally, the treatment fluids of the present invention may comprise a dispersant. Suitable examples of dispersants include, but are not limited to, sulfonated styrene maleic anhydride copolymer, sulfonated vinyl toluene maleic anhydride copolymer, sodium naphthalene sulfonate condensed with formaldehyde, sulfonated acetone condensed with formaldehyde, lignosulfonates (e.g., modified sodium lignosulfonate), allyloxybenzene sulfonate, allyl sulfonate and non-ionic monomers, and interpolymers of acrylic acid. An example of a dispersant that may be suitable is commercially available from National Starch & Chemical Company of Newark, N.J. under the trade name “Alcosperse 602 ND,” and is a mixture of 6 parts sulfonated styrene maleic anhydride copolymer to 3.75 parts interpolymer of acrylic acid. Another example of a dispersant that may be suitable is a modified sodium lignosulfonate that is commercially available from Halliburton Energy Services, Inc., of Duncan, Okla., under the trade name “HR®-5.” Where included, the dispersant may be present from about 0.0001% to about 4% by weight of the treatment fluid. In other embodiments, the dispersant may be present from about 0.0003% to about 0.1% by weight of the treatment fluid. One skilled in the art, with the benefit of this disclosure, will recognize the appropriate amount of dispersant for inclusion in the treatment fluids of the present invention for a particular application.

Optionally, the treatment fluids of the present invention may comprise surfactants. Suitable examples of surfactants include, but are not limited to, nonylphenol ethoxylates, alcohol ethoxylates, sugar lipids, α-olefinsulfonates, alkylpolyglycosides, alcohol sulfates, salts of ethoxylated alcohol sulfates, alkyl amidopropyl dimethylamine oxides, and alkene amidopropyl dimethylamine oxides. An example of a surfactant that may be suitable comprises an oxyalkylatedsulfonate, and is commercially available from Halliburton Energy Services, Inc. under the trade name “STABILIZER 434C.” Another surfactant that may be suitable comprises an alkylpolysaccharide, and is commercially available from Seppic, Inc., of Fairfield, N.J. under the trade designation “SIMUSOL-10.” Another surfactant that may be suitable comprises ethoxylated nonylphenols, and is commercially available under the trade name “DUAL SPACER SURFACTANT A” from Halliburton Energy Services, Inc. Where included, the surfactant may be present from about 0.01% to about 10% by weight of the treatment fluid. In other embodiments of the present invention, the surfactant may be present from about 0.01% to about 6% by weight of the treatment fluid. One skilled in the art, with the benefit of this disclosure will recognize the appropriate amount of surfactant for a particular application.

Optionally, the treatment fluids of the present invention may comprise weighting agents. Generally, any weighting agent may be used with the treatment fluids of the present invention. Suitable weighting materials may include barium sulfate (BaSO₄, commonly known as Barite), MICROMAX™ (available from Halliburton Energy Services in Duncan, Okla.), MICROMAX FF (available from Halliburton Energy Services in Duncan, Okla.) hematite, manganese tetraoxide, ilmenite, calcium carbonate, and the like. An example of a suitable hematite is commercially available under the trade name “Hi-Dense® No. 4” from Halliburton Energy Services, Inc. Where included, the weighting agent may be present in the treatment fluid in an amount sufficient to provide a desired density to the treatment fluid. In certain embodiments, the weighting agent may be present in the treatment fluids of the present invention in the range from about 0.01% to about 85% by weight. In other embodiments, the weighting agent may be present in the treatment fluids of the present invention in the range from about 15% to about 70% by weight. One of ordinary skill in the art, with the benefit of this disclosure, will recognize the appropriate amount of weighting agent to use for a chosen application.

Optionally, the treatment fluids of the present invention may comprise a chelating agent. When added to the treatment fluids of the present invention, such a chelating agent may chelate any dissolved divalent or trivalent cation that may be present in the base liquid. Any suitable chelating agent can be used with the present invention. Examples of suitable chelating agents include, but are not limited to, an anhydrous form of citric acid, commercially available under the tradename FE-2™ iron sequestering agent from Halliburton Energy Services, Inc., of Duncan, Okla. Another example of a suitable chelating agent is a solution of citric acid dissolved in water, commercially available under the tradename Fe-2A™ buffering agent from Halliburton Energy Services, Inc., of Duncan, Okla. Another example of a suitable chelating agent is sodium citrate, commercially available under the tradename FDP-S714-04 from Halliburton Energy Services, Inc., of Duncan, Okla. Other chelating agents that are suitable for use with the present invention may include, inter alia, nitrilotriacetic acid and any form of ethylene diamine tetracetic acid (“EDTA”), Ethylene glycol tetraacetic acid (EGTA), or their salts. Suitable chelating agents for use with the fluids of the present invention may also include tartaric acid, polycarboxylic acids, lignosulphonates, Phosphonates/Organo Phosphonates-1, Hydroxyethylidene diphoshponic acid (“HEDP”), Diethylene triamine penta (methylene phosphonic) acid (“DETMP”), amino-tri-methylene phosphonic acid (“ATMP”), ethylene diamine tetra (methylene phosphonic) acid (“EDTMP”), any salts thereof, any derivatives thereof, and any combinations thereof. When used, the iron chelating agent is preferably included in the fluid from about 0.1% to about 1% by weight of the fluid.

Optionally, the treatment fluids of the present invention may comprise a 5.80% vitrified shale, 0.35% bentonite, and 0.07% TAU MOD™.

Other additives may be added to the treatment fluids of the present invention as deemed appropriate by one skilled in the art with the benefit of this disclosure. Examples of such additives include defoamers, curing agents, salts, corrosion inhibitors, scale inhibitors, and formation conditioning agents. One of ordinary skill in the art with the benefit of this disclosure will recognize the appropriate type of additive for a particular application.

In order to judge the performance of a spacer fluid, rheology is determinative, particularly the consistency of the yield point at elevated temperature. Certain embodiments of the spacer fluids of the present invention may demonstrate improved “300/3” ratios. As referred to herein, the term “300/3” ratio will be understood to mean the value which results from dividing the shear stress that a fluid demonstrates at 300 rpm by the shear stress that the same fluid demonstrates at 3 rpm. Preferably, spacer fluids exhibit a “300/3” ratio at or near 1.0, indicating that the rheology of such fluid is flat. Flat rheology facilitates maintenance of nearly uniform fluid velocities across a subterranean annulus, and helps maintain a near-constant shear stress profile. In certain embodiments, flat rheology may reduce the volume of a spacer fluid that is required to effectively clean a subterranean wellbore. While flat rheology is preferred, it is not required of the spacer fluids of the present invention. Certain embodiments of the fluids of the present invention may demonstrate 300/3 ratios in the range of from about 2.0 to about 5.0. Other embodiments of the fluids of the present invention may demonstrate 300/3 ratios in the range of from about 2.7 to about 4.2. Some preferred embodiments of the fluids of the present invention may maintain a flat (ratio of about 1) rheology across a wide temperature range.

The fluids of the present invention may be prepared in a variety of ways. In certain embodiments of the present invention, the well fluids of the present invention may be prepared by first pre-blending the vitrified shale with any chosen, optional dry additives. Next, those blended dry materials may be mixed with base fluid, either by batch mixing or continuous (“on-the-fly”) mixing. In certain embodiments of the present invention wherein the blended dry materials are mixed with base fluid by batch mixing, the base fluid may have been premixed with weak organic acid and/or a defoamer. The dry blend then may be added to the base fluid using, e.g., an additive hopper with venturi effects; the mixture of the dry blend and the base fluid also may be agitated, after which the weighting material may be added and agitated. Surfactants may be added to the spacer fluid shortly before it is placed down hole. In certain embodiments of the present invention wherein the blended dry materials are mixed with base fluid by continuous mixing, the blended dry materials typically will be further blended with a weighting material, and the resulting mixture may be metered into, e.g., recirculating cement mixing equipment while the base fluid is metered in separately. The base fluid typically will comprise defoamers pre-blended therein. Shortly before the spacer fluid is placed down hole, surfactants may be added to the spacer fluid.

An example of a method of the present invention is a method of displacing a fluid in a wellbore, comprising: providing a wellbore having a first fluid disposed therein; and placing a second fluid into the wellbore to at least partially displace the first fluid therefrom, wherein the second fluid comprises vitrified shale, TUNED SPACER™ III blend (available from Halliburton Energy Services Inc., of Duncan, Okla.), weighting agent (e.g., Barite, MICROMAX™, MICROMAX FF, hematite), THERMA VIS™, TAU MOD™, bentonite, salt, surfactants, Fe-2 (chelating agent), and a base fluid.

Another example of a method of the present invention is a method of separating fluids in a wellbore in a subterranean formation, comprising: providing a wellbore having a first fluid disposed therein; placing a spacer fluid in the wellbore to separate the first fluid from a second fluid, the spacer fluid comprising a vitrified shale, TUNED SPACER™ III blend, weighting agent (e.g., Barite, MICROMAX™, MICROMAX FF, hematite), THERMA VIS™, TAU MOD™, bentonite, salt, surfactants, Fe-2 (chelating agent), and a base fluid; and placing the second fluid in the wellbore.

One example of a preferred spacer fluid of the present invention comprises, by weight, about 51% water, about 3% vitrified shale, about 44% weighing agent (such as Barite), about 1% clay mineral (such as sepiolite), about 0.03% viscosifier (such as hydroxyethyl cellulose), about 0.1% high molecular weight welan polysaccharide (such as BIOZAN), about 0.006% dispersant (such as modified sodium lignosulfonate), and about 0.55% citric acid, which may be added to chelate calcium, which may inhibit polymer hydration.

To facilitate a better understanding of the present invention, the following examples of preferred embodiments are given. In no way should the following examples be read to limit, or to define, the scope of the invention.

### Example 1

Rheological testing was performed on a variety of sample compositions that were prepared as follows:

(1) Dry components (e.g., vitrified shale, or zeolite, or fumed silica) were mixed and dry additives, plus dry additives such as, for example, hydroxyethylcellulose, BIOZAN, and sodium lignosulfonate were weighed into a glass container having a clean lid, and thoroughly agitated by hand until well blended. Tap water then was weighed into a Waring blender jar, and the blender turned on at 4,000 rpm. While the blender continued to turn, citric acid was added to the mixing water, and then the blended dry components were added, followed by the Barite. The blender speed then was increased to 12,000 rpm for about 35 seconds. Afterwards, the blender was stopped, and about 2 drops of a standard, glycol-based defoamer were added.

Rheological values then were determined using a Fann Model 35 viscometer. Dial readings were recorded at speeds of 3, 6, 30, 60, 100, 200, 300, and 600 RPM with a B1 bob, an R1 rotor, and a 1.0 spring.

In the Sample Compositions described below, all concentrations are in weight percent.

Sample Composition No. 1 comprised a 10 pound per gallon slurry of 75.6% water, 4.83% zeolite, 1.63% sepiolite, 0.04% hydroxyethylcellulose, 0.11% BIOZAN, 0.71% sulfonated styrene copolymer, 0.72% citric acid, and 16.36% Barite.

Sample Composition No. 2 comprised a 10 pound per gallon slurry of 75.6% water, 4.83% fumed silica, 1.63% sepiolite, 0.04% hydroxyethylcellulose, 0.11% BIOZAN, 0.71% sulfonated styrene copolymer, 0.72% citric acid, and 16.36% Barite.

Sample Composition No. 3 comprised a 10 pound per gallon slurry of 75.6% water, 5.49% vitrified shale, 1.61% sepiolite, 0.07% hydroxyethylcellulose, 0.14% BIOZAN, 0.01% modified sodium lignosulfonate, 0.72% citric acid, and 16.36% Barite.

Sample Composition No. 4 comprised a 13 pound per gallon slurry of 51.39% water, 2.81% zeolite, 0.95% sepiolite, 0.02% hydroxyethylcellulose, 0.06% BIOZAN, 0.41% sulfonated styrene copolymer, 0.55% citric acid, and 43.81% Barite.

Sample Composition No. 5 comprised a 13 pound per gallon slurry of 51.39% water, 2.81% fumed silica, 0.95% sepiolite, 0.02% hydroxyethylcellulose, 0.06% BIOZAN, 0.41% sulfonated styrene copolymer, 0.55% citric acid, and 43.81% Barite.

Sample Composition No. 6 comprised a 13 pound per gallon slurry of 51.39% water, 3.19% vitrified shale, 0.94% sepiolite, 0.034% hydroxyethylcellulose, 0.08% BIOZAN, 0.006% modified sodium lignosulfonate, 0.55% citric acid, and 43.81% Barite.

Sample Composition No. 7 comprised a 16 pound per gallon slurry of 36.22% water, 1.54% zeolite, 0.52% sepiolite, 0.01% hydroxyethylcellulose, 0.04% BIOZAN, 0.23% sulfonated styrene copolymer, 0.45% citric acid, and 60.98% Barite.

Sample Composition No. 8 comprised a 16 pound per gallon slurry of 36.22% water, 1.54% fumed silica, 0.52% sepiolite, 0.01% hydroxyethylcellulose, 0.04% BIOZAN, 0.23% sulfonated styrene copolymer, 0.45% citric acid, and 60.98% Barite.

Sample Composition No. 9 comprised a 16 pound per gallon slurry of 36.22% water, 1.76% vitrified shale, 0.52% sepiolite, 0.023% hydroxyethylcellulose, 0.044% BIOZAN, 0.003% modified sodium lignosulfonate, 0.45% citric acid, and 60.98% Barite.

The results of the testing are set forth in the tables below. The abbreviation “PV” stands for plastic viscosity, while the abbreviation “YP” refers to yield point.

TABLE 2

| Sample | | Viscometer RPM | | | | | | | | | |
|---|---|---|---|---|---|---|---|---|---|---|---|
| Composition | Temp. | 600 | 300 | 200 | 100 | 60 | 30 | 6 | 3 | PV | YP |
| 1 | 80 F. | 43 | 30 | 25 | 19 | 15 | 12 | 7 | 6 | 19.5 | 11.9 |
| 1 | 135 F. | 35 | 26 | 21 | 16 | 13 | 11 | 7 | 5 | 16.4 | 10.5 |
| 1 | 190 F. | 31 | 23 | 20 | 16 | 14 | 12 | 9 | 8 | 12 | 12.2 |
| 2 | 80 F. | 40 | 27 | 23 | 19 | 16 | 14 | 9 | 7 | 14.1 | 14.2 |
| 2 | 135 F. | 32 | 24 | 21 | 18 | 15 | 12.5 | 9 | 8 | 12.1 | 13.4 |
| 2 | 190 F. | 29 | 21 | 18 | 15 | 13 | 12 | 9 | 7.5 | 9.9 | 11.9 |
| 3 | 80 F. | 49 | 35 | 29 | 21 | 17 | 13 | 8 | 7 | 18.0 | 15.0 |
| 3 | 135 F. | 49 | 36 | 30 | 23 | 19 | 16 | 10 | 9 | 17 | 18 |
| 3 | 190 F. | 39 | 29 | 24 | 18 | 15 | 12 | 8 | 7 | 14 | 14 |

TABLE 3

| Sample | | Viscometer RPM | | | | | | | | | |
|---|---|---|---|---|---|---|---|---|---|---|---|
| Composition | Temp. | 600 | 300 | 200 | 100 | 60 | 30 | 6 | 3 | PV | YP |
| 4 | 80 F. | 102 | 72 | 59 | 43 | 35 | 28 | 17 | 15 | 48.1 | 26.8 |
| 4 | 135 F. | 77 | 55 | 46 | 36 | 30 | 25 | 16 | 14 | 32.5 | 24.9 |
| 4 | 190 F. | 55 | 40 | 33 | 25 | 21 | 17 | 11 | 10 | 24.9 | 16.7 |
| 5 | 80 F. | 89 | 63 | 51 | 37 | 30 | 23 | 14 | 12 | 43.3 | 22.2 |
| 5 | 135 F. | 63 | 46 | 38 | 29 | 24 | 19 | 12 | 11 | 29 | 19 |
| 5 | 190 F. | 45 | 34 | 27 | 20 | 18 | 15 | 10 | 8 | 20.6 | 14.1 |
| 6 | 80 F. | 84 | 59 | 49 | 37 | 32 | 24 | 16 | 14 | 30.0 | 28.0 |
| 6 | 135 F. | 65 | 46 | 38 | 28 | 23 | 18 | 12 | 10 | 24 | 20 |
| 6 | 190 F. | 51 | 37 | 31 | 24 | 20 | 17 | 11 | 10 | 18 | 19 |

TABLE 4

| Sample | | Viscometer RPM | | | | | | | | | |
|---|---|---|---|---|---|---|---|---|---|---|---|
| Composition | Temp. | 600 | 300 | 200 | 100 | 60 | 30 | 6 | 3 | PV | YP |
| 7 | 80 F. | 172 | 123 | 101 | 75 | 62 | 50 | 36 | 31 | 79.5 | 48.5 |
| 7 | 135 F. | 127 | 92 | 77 | 58 | 49 | 41 | 28 | 26 | 56 | 40 |
| 7 | 190 F. | 105 | 76 | 65 | 51 | 45 | 37 | 27 | 23 | 41.9 | 37.8 |
| 8 | 80 F. | 177 | 127 | 105 | 79 | 65 | 52 | 37 | 34 | 81.3 | 51.2 |
| 8 | 135 F. | 114 | 82 | 69 | 53 | 46 | 39 | 28 | 25 | 47 | 38.4 |
| 8 | 190 F. | 95 | 69 | 57 | 44 | 37 | 31 | 22 | 20 | 41.2 | 30.4 |
| 9 | 80 F. | 109 | 82 | 69 | 52 | 44 | 36 | 26 | 23 | 38.0 | 40.0 |
| 9 | 135 F. | 92 | 67 | 56 | 44 | 37 | 31 | 23 | 21 | 31 | 34 |
| 9 | 190 F. | 75 | 56 | 48 | 39 | 34 | 29 | 22 | 21 | 23 | 32 |

The above example demonstrates, inter alia, that the improved treatment fluids of the present invention comprising vitrified shale and a base fluid may be suitable for use in treating subterranean formations.

### Example 2

Additional Rheological testing was carried out on several fluids having the following compositions.

Sample Composition No. 10, a well fluid of the present invention, comprised 60.98% fresh water by weight, 1.76% vitrified shale by weight, 36.22% barium sulfate by weight, 0.52% sepiolite by weight, 0.023% hydroxyethyl cellulose by weight, 0.044% BIOZAN by weight, 0.003% modified sodium lignosulfonate by weight, and 0.45% citric acid by weight.

Sample Composition No. 11 comprised 0.97% bentonite by weight, 27.79% silica flour by weight, 0.2% carboxymethyl hydroxyethyl cellulose by weight, 40.04% barium sulfate by weight, 0.37% by weight of sodium napthalene sulfonate condensed with formaldehyde, and 31.63% fresh water by weight.

Sample Composition No. 12 comprised 2.03% diatomaceous earth by weight, 1.82% coarse silica by weight, 0.1% attapulgite by weight, 0.63% sepiolite by weight, 0.52% by weight of sodium napthalene sulfonate condensed with formaldehyde, 0.1% propylene glycol by weight, 59.1% barium sulfate by weight, and 35.7% fresh water by weight.

The compositions were tested to determine their “300/3” ratios. A viscometer using an R-1 rotor, a B-1 bob, and an F-1 spring was used. The dial readings at 300 RPM (511 sec −1 of shear) were divided by dial readings obtained at 3 RPM (5.11 sec −1 of shear). The results of the testing are set forth in the table below.

TABLE 5

| | Sample | Sample | Sample |
|---|---|---|---|
| | Compo- | Compo- | Compo- |
| Rheology | sition 10 | sition 11 | sition 12 |
| 300/3 ratio at 80° F. | 4.2 | 11.0 | 9.0 |
| 300/3 ratio at 135° F. | 2.7 | 7.8 | 5.8 |
| 300/3 ratio at 190° F. | 3.0 | 5.3 | 5.6 |

### Example 3

Additional Rheological testing was carried out using a Fann Model 75 viscometer. Dial readings were recorded at speeds of 3, 6, 100, 200, 300, and 600 RPM.

Sample Composition No. 13 was prepared as described in Table 6, below.

TABLE 6
Sample Composition No. 13

| | Specific | Mass | Volume | |
|---|---|---|---|---|
| Material | Gravity | (Kg) | (Lit) | wt % |
| Water | 1 | 298.5 | 298.5 | 34.62 |
| TUNED SPACER ™ III blend | 2.5 | 10.0 | 4.00 | 1.16 |
| Barite | 4.2 | 488.00 | 115.37 | 56.61 |
| Fe-2 | 1.54 | 2.00 | 1.30 | 0.23 |
| THERMA VIS ™ | 1 | 10.00 | 10.00 | 1.16 |
| Vitrified Shale | 2.65 | 50.00 | 18.87 | 5.8 |
| Bentonite | 2.65 | 3.00 | 1.13 | 0.35 |
| TAU MOD ™ | 2.1 | 0.60 | 0.29 | 0.07 |
| Total | | 862.10 | 449.45 | |

| | |
|---|---|
| Density (kg/lit) | 1.92 |
| Density (ppg) | 16.00 |

TUNED SPACER™ III blend is a water-based spacer fluid that comprises from about 60-80 weight % vitrified shale, from about 5-20% sepiolite, from about 5-20% diatomaceous earth (e.g., MN-51 (diatom)), and from about 1-10% BIOZAN. Thus, it provides vitrified shale and a mixture of viscosifying agents (sepiolite and diatomaceous earth and BIOZAN).

Sample Composition No. 13 was then tested for plastic viscosity and yield point in at elevated temperature, as described in Table 7.

TABLE 7

| Sample | | Press. | Viscometer RPM | | | | | | | YP |
|---|---|---|---|---|---|---|---|---|---|---|
| Composition | Temp. | (psi) | 600 | 300 | 200 | 100 | 6 | 3 | PV (cp) | (lb/100 ft²) |
| 13 | 80 F. | | 104 | 63 | 50 | 39 | 23 | 23 | 40.2 | 24.5 |
| 13 | 200 F. | 2000 | 64 | 41 | 33 | 28 | 23 | 23 | 20.5 | 22.8 |
| 13 | 300 F. | 2000 | 55 | 38 | 32 | 29 | 22 | 21 | 16.5 | 23 |
| 13 | 400 F. | 4000 | 44 | 29 | 27 | 23 | 17 | 17 | 13.2 | 18.3 |
| 13 | 450 F. | 4000 | 82 | 52 | 43 | 36 | 29 | 29 | 26.4 | 29 |

The results of the testing are set forth show that Sample Composition No. 13 demonstrated a desired yield point in the range of 20-30 lb/100 ft². Thus, the above example demonstrates that the improved treatment fluids of the present invention allow for the rheologies of the treatment fluids to be tunable as desired and at elevated temperatures (e.g., 450° F.), such that they may hold weighting material above 300° F. without thinning out significantly at high temperatures. Moreover, the sample was easy to mix with varying densities, and exhibited a yield point that remained relatively consistent over a wide temperature range (e.g., 80° F. to 450° F.). Thus, while some treatment fluids may lose yield point at temperatures between 325° F. and 350° F., the treatment fluids of the present invention have been shown to maintain yield point to 450° F., and likely to as high as 500° F.

Compatibility of Sample Composition 13 was compared with a 15 ppg water based drilling fluid at 180° F. and 16 ppg cement slurry. The water based drilling fluid tested was received without data specifying its components but was labeled as suitable for use at a BHST of 450° F. The make up of the 16 ppg cement slurry is set forth in Table 8, below.

TABLE 8
Cement Slurry Density 16 lb/gal (ppg)
Yield 1.23 (cu ft/sk)
S.G. 1.917
Sack Weight 69.60 (lb/sk)
Gram Basis 500 (grams)
Water 4.27 (gal/sk)
Total Fluid 4.69 (gal/sk)

| | | | Weight | Specific | % |
|---|---|---|---|---|---|
| Material | Amount | Unit | (gram) | Gravity | Solids |
| Water | 51.16 | % | 255.8 | 0.998 | 0.0 |
| | | bwc | | | |
| ABC HTB CLASS G | 69.600 | Lb/sk | 500.0 | 3.190 | 100.0 |
| (Class G | | | | | |
| Portland Cement) | | | | | |
| SSA-1 (silica | 15.00 | % | 75.0 | 2.630 | 100.0 |
| flour) | | bwc | | | |
| Halad-200 (polymer- | 1.00 | % | 5.0 | 1.370 | 100.0 |
| based fluid loss | | bwc | | | |
| additive) | | | | | |
| GasCon 469 (silica | 0.420 | gal/sk | 27.7 | 1.100 | 15.0 |
| fume suspension) | | | | | |
| FDP-742A (acid- | 1.10% | bwc | 5.5 | 1.190 | 100.0 |
| based retarder) | | | | | |
| Component R | 0.55 | % | 2.8 | 1.750 | 100.0 |
| (borate-based | | bwc | | | |
| retarder) | | | | | |
| NF-6 (defoamer) | 0.020 | gal/sk | 1.1 | 0.930 | 100.0 |
| CFR-3 (dispersant) | 1.75 | % | 8.8 | 1.280 | 100.0 |
| | | bwc | | | |
| SSA-1 (silica | 24.400 | lb/sk | 175.3 | 2.630 | 100.0 |
| flour) | | | | | |

For the compatibility testing, the various ratios of drilling fluid to spacer and spacer to cement compositions were prepared as per Table 9. These slurries were individually conditioned in the Fann Atmospheric consistometer at 180° F. for 20 minutes and tested for rheology on Fann model 35 at 180° F. The results are summarized in same Table 9 below.

TABLE 9

| Fluid Mixture | Fann Model 35 - Viscometer Dial Readings (180 F.) | | | | | | | |
|---|---|---|---|---|---|---|---|---|
| (% By Volume) | 600 | 300 | 200 | 100 | 60 | 30 | 6 | 3 |
| 100% Mud | 28 | 21 | 19 | 17 | 16 | 16 | 15 | 15 |
| 95% Mud 5% | 31 | 25 | 20 | 18 | 17 | 17 | 16 | 16 |
| Spacer | | | | | | | | |
| 75% Mud 25% | 29 | 22 | 20 | 17 | 16 | 15 | 15 | 14 |
| Spacer | | | | | | | | |
| 50% Mud 50% | 35 | 24 | 21 | 17 | 16 | 16 | 15 | 13 |
| Spacer | | | | | | | | |
| 25% Mud 75% | 52 | 34 | 26 | 20 | 18 | 18 | 16 | 15 |
| Spacer | | | | | | | | |
| 5% Mud 95% | 62 | 55 | 34 | 27 | 24 | 20 | 20 | 18 |
| Spacer | | | | | | | | |
| 100% Spacer | 72 | 47 | 40 | 31 | 24 | 19 | 18 | 18 |
| 95% Spacer 5% | 130 | 92 | 70 | 55 | 45 | 40 | 35 | 30 |
| CMT | | | | | | | | |
| 75% Spacer 25% | 155 | 114 | 85 | 63 | 58 | 48 | 48 | 47 |
| CMT | | | | | | | | |
| 50% Spacer 50% | 160 | 115 | 88 | 55 | 42 | 31 | 19 | 12 |
| CMT | | | | | | | | |
| 25% Spacer 75% | 178 | 123 | 92 | 60 | 45 | 25 | 10 | 8 |
| CMT | | | | | | | | |
| 5% Spacer 95% | 292 | 164 | 117 | 68 | 48 | 28 | 10 | 7 |
| CMT | | | | | | | | |
| 100% Cement | 234 | 130 | 95 | 55 | 37 | 22 | 8 | 6 |

For interpretation of the results obtained from Fann model 35 and as tabulated in Table 9, the results were calculated as indicated below, discussed as per Case 1 and Case 2, wherein the fluids were pumped at 8 bpm (Case 1) and 5 bpm (Case 2) for a casing ID of 9.625 in. and wellbore ID of 11.75 in. using an annulus geometry. The calculated rpm for Case 1 was 105 rpm and for Case 2 was 66 rpm.

### Case 1

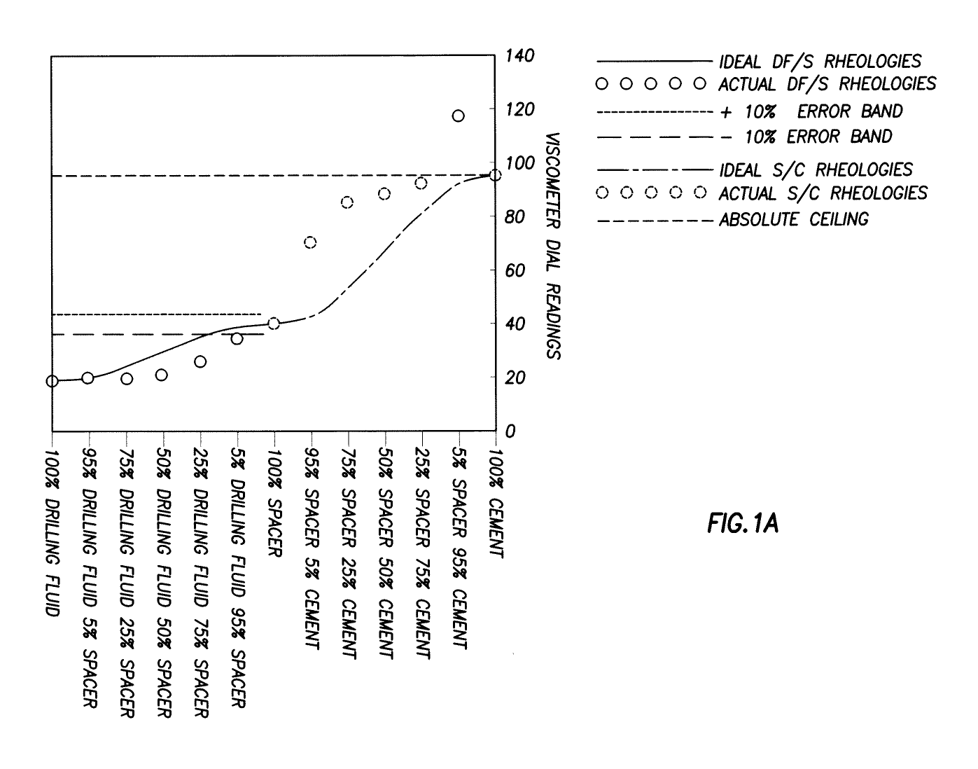

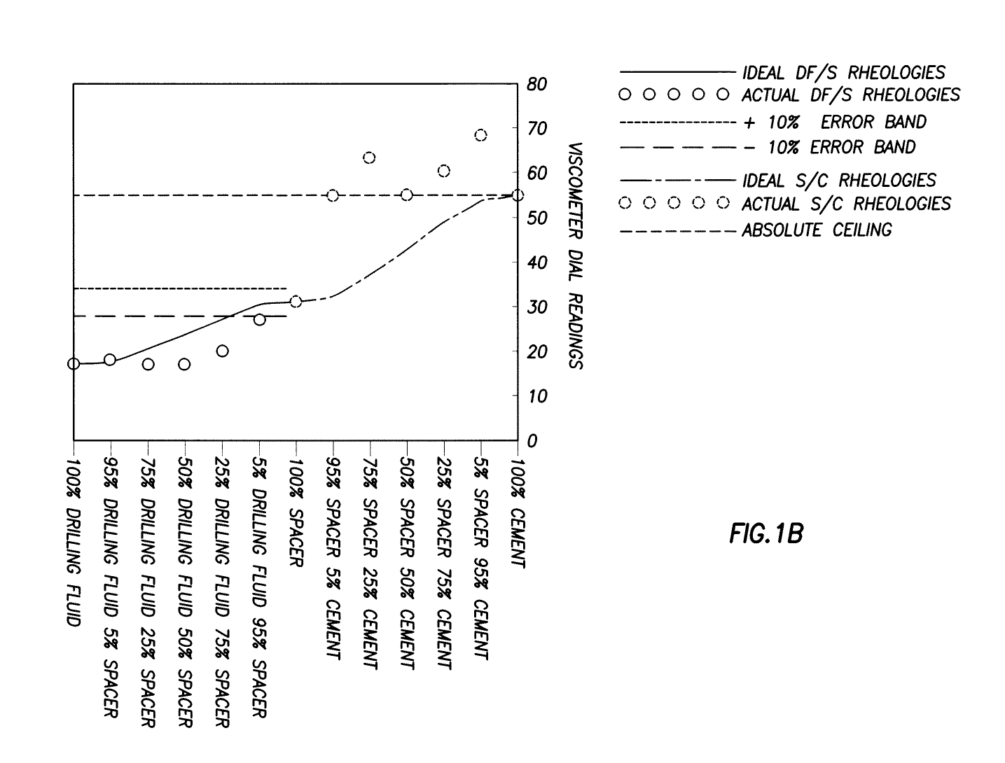

As indicated in FIGS. 1A and 1B, the spacer showed excellent compatibility with the drilling fluid ahead and the cement behind.

### Case 2

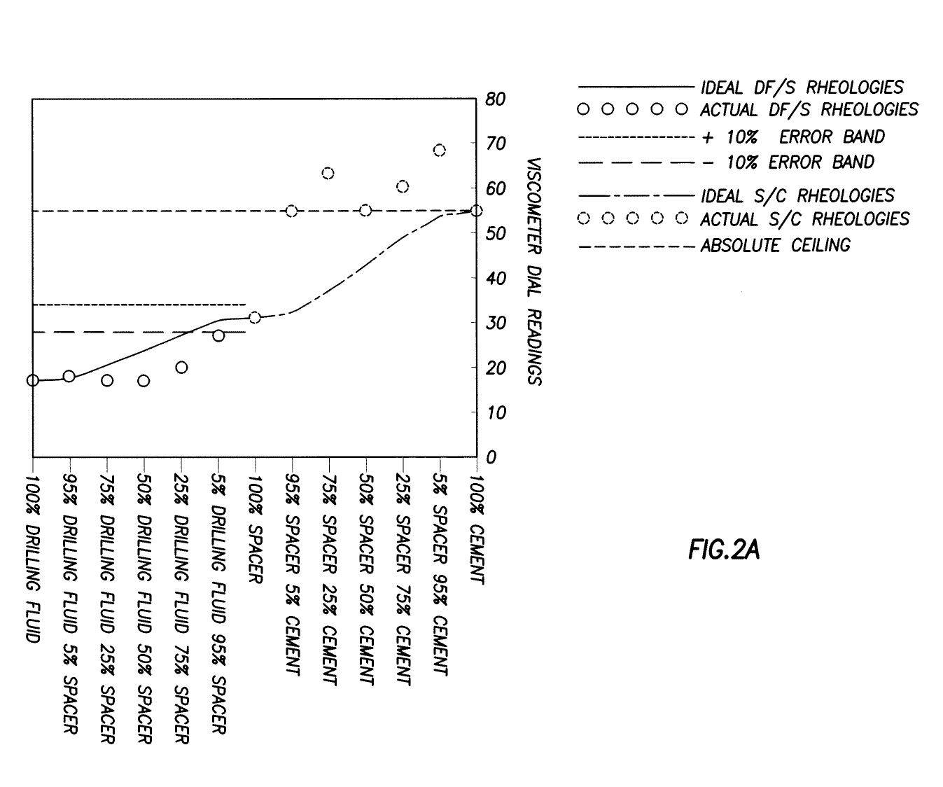

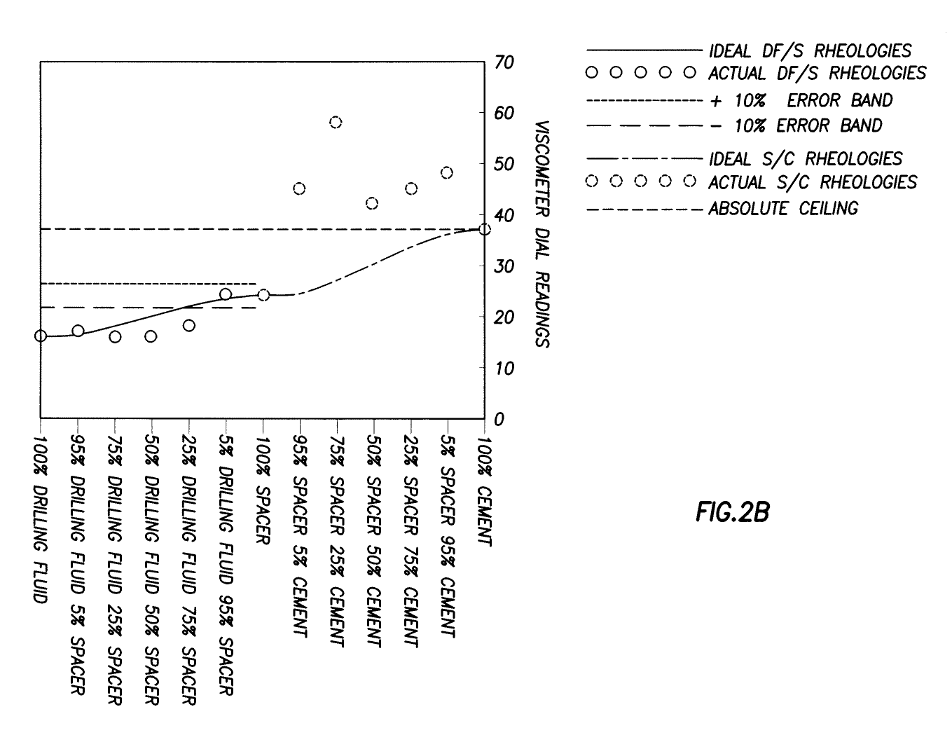

As indicated in FIGS. 2A and 2B, the spacer showed very good compatibility with the drilling fluid ahead. The spacer to cement is also very close to the limits of ideal compatibilities with the nearest shear rate rounded up.

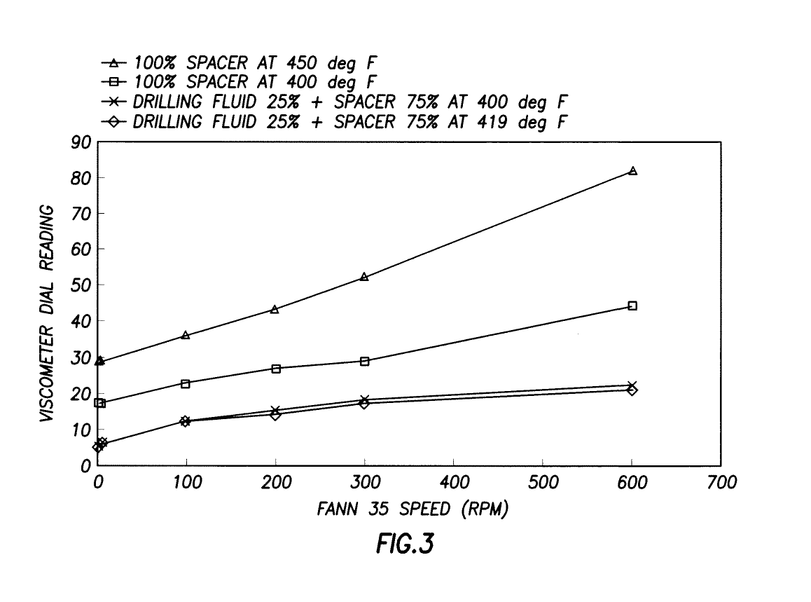

In order to check the compatibility of drilling fluid with spacer, a mixture containing 25% drilling fluid and 75% spacer was prepared and tested on Fan Model 75 at 400° F. and 419° F. (note rheology at 400° F. and 450° F. are indicated in Table 7). The high temperature rheology results are tabulated in Table 10 below and graphically expressed in FIG. 3. From FIG. 3, we can conclude that the designed 16 ppg spacer is compatible to 15 ppg water based drilling fluid.

TABLE 10

| Viscom- | Drilling Fluid | Drilling Fluid | | |
|---|---|---|---|---|
| eter | 25% + Spacer | 25% + Spacer | 100% Spacer | 100% Spacer |
| RPM | 75% at 400 F. | 75% at 419 F. | at 400 F. | at 450 F. |
| 600 | 22 | 21 | 44 | 82 |
| 300 | 18 | 17 | 29 | 52 |
| 200 | 15 | 14 | 27 | 43 |
| 100 | 12 | 12 | 23 | 36 |
| 6 | 6 | 6 | 17 | 29 |
| 3 | 5 | 5 | 17 | 29 |

### Example 4

Additional Rheological testing was carried out with a Fann Model 75, with recordings noted at speeds of 3, 6, 30, 60, 100, 200, 300, and 600 RPM.

Sample Composition No. 14, described in Table 11, was prepared as follows: (1) dry blend TUNED SPACER™ III blend, Fe-2 and slowly add to water and hydrate for a maximum of 10 minutes, (2) add the required quantity of bentonite to the slurry and hydrate for 5 minutes, (3) add the required quantity of TAU MOD™ to the slurry and hydrate for 5 minutes, (4) dry blend THERMA VIS™, vitrified shale and Barite and slowly add to the hydrated TUNED SPACER™ slurry in 10 minutes, and (5) keep stirring at 1000 rpm and homogenize for 15-20 minutes.

TABLE 11
Sample Composition No. 14

| | Specific | Mass | Volume | |
|---|---|---|---|---|
| Material | Gravity | (Kg) | (Lit) | wt % |
| Water | 1.00 | 254.0 | 5254.00 | 28.94 |
| TUNED SPACER ™ III blend | 2.50 | 8.5 | 3.40 | 0.97 |
| Barite | 4.23 | 535.00 | 126.48 | 60.95 |
| Fe-2 | 1.54 | 2.00 | 1.30 | 0.23 |
| THERMA VIS ™ | 1.00 | 6.00 | 6.00 | 0.68 |
| Vitrified Shale | 2.65 | 70.00 | 26.42 | 7.97 |
| Bentonite | 2.65 | 2.00 | 0.75 | 0.23 |
| TAU MOD ™ | 2.10 | 0.30 | 0.14 | 0.03 |
| Total | | 877.79 | 418.48 | |

| | |
|---|---|
| Density (kg/lit) | 17.50 |
| Density (ppg) | 17.5 |

Sample Composition No. 14 was tested for PV and YP at high temperature (400° F.) and the results of the testing are set forth in Table 12, below.

TABLE 12

| Sample | | Press. | Viscometer RPM | | | | | | | | | |
|---|---|---|---|---|---|---|---|---|---|---|---|---|
| Composition | Temp. | (psi) | 600 | 300 | 200 | 100 | 60 | 30 | 6 | 3 | PV | YP |
| 14 | 80 F. | | 114 | 70 | 54 | 38 | 31 | 26 | 25 | 25 | 45.5 | 24.5 |
| 14 | 400 F. | 2000 | 66 | 42 | 34 | 26 | 25 | 24 | 23 | 22 | 21.88 | 22.13 |

From the results, it is evident that the designed 17.5 ppg spacer is stable up to 400° F. and can sustain a desired yield point.

### Example 5

Additional Rheological testing was carried out with a Fann Model 77, with recordings noted at speeds of 3, 6, 30, 60, 100, 200, 300, and 600 RPM.

Sample Composition No. 15 was prepared to give a desired yield point in the range of 10-20 lbf/100 ft² for oil based mud at 350° F. and to hold at this temperature for at least 5 hours, as described in Table 14. Sample composition No. 15 was prepared as follows: (1) weigh 284 ml of water in mixing blender, (2) add 7 gm of D-air −3000 to mixing water, (3) add 1 gm KCl and stir at 1000 rpm for 2 minutes, (4) weigh appropriately TUNED SPACER™ III blend, bentonite, vitrified shale and THERMA VIS™ and dry blend them and then slowly add to the mixing water at 2000 rpm in 2-3 minutes, (5) agitate for 10 minutes, (6) weigh 488 gm Barite and slowly add to mixing water at 2000 rpm and agitate for further 10 minutes, (7) weigh DSSA and DSSB and add to the prepared spacer and hand blend it or stir at 50-100 rpm, (8) prepare the Fann model 77/75 assembly and pour the prepared spacer in the cell and start the test.

TABLE 13
Sample Composition No. 15

| | Specific | Mass | Volume | |
|---|---|---|---|---|
| Material | Gravity | (Kg) | (Lit) | wt % |
| Water | 1.00 | 284.0 | 284.00 | 33.17 |
| D-Air 3000 | 0.90 | 7.0 | 7.78 | 0.82 |
| TUNED SPACER ™ III blend | 2.50 | 5.5 | 2.20 | 0.64 |
| TAU MOD ™ | 2.10 | 0.00 | 0.00 | 0.47 |
| Bentonite | 2.65 | 4.00 | 1.51 | 5.84 |
| BASF (pressure seal/vitrified | 2.65 | 50.00 | 18.87 | 0.12 |
| shale) | | | | |
| KCL | 1.99 | 1.00 | 0.50 | 0.64 |
| THERMA VIS ™ | 1.00 | 5.50 | 5.50 | 0.64 |
| Dual Purpose surfactant A | 1.02 | 5.50 | 5.39 | 0.68 |
| Dual Purpose surfactant B | 1.06 | 5.80 | 5.47 | 0.64 |
| Barite | 4.23 | 488.00 | 115.37 | 0.68 |
| Total | | 856.30 | 446.59 | |

| | |
|---|---|
| Calculated Density (ppg) | 16.00 |
| Density Desired (lb/gal) | 16 |

The results of the testing are set forth in the table below.

TABLE 14

| | Time of | | | | | | | | | | | | |
|---|---|---|---|---|---|---|---|---|---|---|---|---|---|
| Sample | Reading | | Press. | Viscometer RPM | | | | | | | | | |
| Comp. | (hr:min) | Temp. | (psi) | 600 | 300 | 200 | 100 | 60 | 30 | 6 | 3 | PV | YP |
| 15 | 0:10 | 80 F. | | 79 | 58 | 39 | 24 | 17 | 12 | 9 | 9 | 45 | 9.5 |
| 15 | 1:15 | 300 F. | 3000 | 44 | 26 | 21 | 18 | 16 | 14 | 12 | 12 | 15.5 | 12.6 |
| 15 | 1:40 | 350 F. | 3000 | 44 | 30 | 25 | 18 | 17 | 16 | 15 | 15 | 14.9 | 15.3 |
| 15 | 2:46 | 350 F. | 3000 | 39 | 24 | 22 | 17 | 16 | 15 | 14 | 14 | 12.3 | 14.3 |
| 15 | 4:45 | 350 F. | 3000 | 43 | 27 | 22.5 | 19 | 18 | 17 | 16 | 16 | 12.8 | 16.1 |
| 15 | 5:30 | 350 F. | 3000 | 58 | 38 | — | 24 | 21 | 21 | 17 | 17 | 20 | 18.8 |

### Example 6

Additional Rheological testing was carried out with a Fann Model 75, at 80° F., 190° F., 300° F., and 392° F. with recordings noted at speeds of 3, 6, 30, 60, 100, 200, 300, and 600 RPM.

Sample Composition No. 16 was prepared to give a desired yield point of around 10 lbf/100 ft² for synthetic oil based mud/oil based mud at 392° F., as described in Table 16. Sample composition No. 16 was prepared as follows: the TUNED SPACER™ III blend was hydrated for 5 minutes, dry blended vitrified shale was added, along with bentonite, THERMA VIS™, and the mixture was agitated at 3000-3500 rpm for 10 minutes. Once the hydration was done and the fluid looked viscosified, Barite was added and agitated further for 10 minutes. Once the spacer is prepared, the required amount of Dual Spacer Surfactant A, Dual Spacer Surfactant B, and SEM-8 were added and hand blended with a spatula. As described in Table 16, Sample Composition No. 16 comprised a 12 pound per gallon slurry of 57.29% water, 0.52% TUNED SPACER™ III blend, 34.72% Barite, 0.69% THERMA VIS™, 4.51% vitrified shale, 1.74% bentonite, 0.17% Dual Spacer Surfactant A (nonylphenol ethoxylate), 0.18% Dual Spacer Surfactant B (nonylphenol ethoxylate), and 0.18% SEM-8 (ammonium salt of ethoxylated alcohol sulfate), as set forth in the table below.

TABLE 15
Sample Composition No. 16

| | Specific | Mass | Volume | |
|---|---|---|---|---|
| Material | Gravity | (Kg) | (Lit) | wt % |
| Water | 1.00 | 330.0 | 330.00 | 57.29 |
| TUNED SPACER ™ III blend | 2.50 | 3.0 | 1.20 | 0.52 |
| Barite | 4.10 | 200.00 | 48.78 | 34.72 |
| THERMA VIS ™ | 1.00 | 4.00 | 4.00 | 0.69 |
| vitrified shale | 2.65 | 26.00 | 9.81 | 4.51 |
| Bentonite | 2.65 | 10.00 | 3.77 | 1.74 |
| Dual Purpose surfactant A | 1.02 | 0.97 | 0.95 | 0.17 |
| Dual Purpose surfactant B | 1.06 | 1.02 | 0.96 | 0.18 |
| SEM 8 | 1.05 | 1.01 | 0.96 | 0.18 |
| Total | | 576.00 | 400.44 | |

| | |
|---|---|
| Calculated Density (ppg) | 12.00 |
| Density Desired (lb/gal) | 12 |

The results of the testing are set forth in the table below.

TABLE 16

| Sample | | Press. | Viscometer RPM | | | | | | | | | |
|---|---|---|---|---|---|---|---|---|---|---|---|---|
| Comp. | Temp. | (psi) | 600 | 300 | 200 | 100 | 60 | 30 | 6 | 3 | PV | YP |
| 16 | 80 F. | | 53 | 34 | 28 | 23 | 22 | 21 | 20 | 19 | 16.6 | 19.6 |
| 16 | 190 F. | 2000 | 29 | 18 | 15 | 13 | 12 | 11 | 10 | 10 | 9.2 | 10.3 |
| 16 | 300 F. | 2000 | 23 | 16 | 14 | 12 | 12 | 11 | 10 | 10 | 6.3 | 10.6 |
| 16 | 392 F. | 2000 | 23 | 18 | 16 | 15 | 14 | 14 | 13 | 13 | 4.9 | 13.8 |

### Example 7

Additional Rheological testing was carried out with a Fann Model 75, at 80° F., 190° F., and 338° F. with recordings noted at speeds of 3, 6, 30, 60, 100, 200, 300, and 600 RPM.

Sample Composition No. 17 was prepared to give a desired yield point in the range of 5-10 lbf/100 ft² for water based mud at 338° F., as described in Table 18. Sample composition No. 17 was prepared as follows: vitrified shale, bentonite, TAU MOD™, TUNED SPACER™ III blend, THERMA VIS™ were dry blended, then the dry blend was added to water and hydrated for 20 minutes before Barite was added and agitated further for 10 minutes.

TABLE 17
Sample Composition No. 17

| | Specific | Mass | Volume | |
|---|---|---|---|---|
| Material | Gravity | (Kg) | (Lit) | Wt % |
| Water | 1.00 | 322.0 | 322.00 | 57.5 |
| TUNED SPACER ™ III blend | 2.50 | 3.0 | 1.20 | 0.54 |
| Bentonite | 2.35 | 3.00 | 1.27 | 0.54 |
| TAU MOD ™ | 0.87 | 2.00 | 2.31 | 0.36 |
| THERMA VIS ™ | 1.00 | 4.00 | 4.00 | 0.71 |
| BASF (vitrified shale) | 2.65 | 26.00 | 9.81 | 4.64 |
| Barite | 4.10 | 200.00 | 48.78 | 35.71 |
| Total | | 560.00 | 389.37 | |

| | |
|---|---|
| Calculated Density (ppg) | 12.00 |
| Density Desired (lb/gal) | 12 |

The results of the testing are set forth in the table below.

TABLE 18

| Sample | | Press. | Viscometer RPM | | | | | | | | | |
|---|---|---|---|---|---|---|---|---|---|---|---|---|
| Comp. | Temp. | (psi) | 600 | 300 | 200 | 100 | 60 | 30 | 6 | 3 | PV | YP |
| 17 | 80 F. | | 52 | 35 | 29 | 22 | 21 | 20 | 18 | 16 | 17.5 | 18.2 |
| 17 | 190 F. | 2000 | 31 | 22 | 19 | 17 | 16 | 16 | 15 | 15 | 7.9 | 15.5 |
| 17 | 338 F. | 2000 | 19 | 13 | 12 | 10 | 9 | 9 | 8 | 8 | 5.3 | 8.5 |

Thus, the treatment fluids of the present invention may satisfy a need of wellbore like high temperature stability (e.g., consistent yield point with increasing temperature), efficient fluid loss control, non-settling fluid at static conditions, ease of mixing, and ease of preparation at high density in the upstream industry.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

1-20. (canceled)

21. A spacer fluid comprising:
a base liquid;
vitrified shale;
a chelating agent selected from the group consisting of nitrilotriacetic acid, ethylene diamine tetracetic acid (EDTA), ethylene glycol tetraacetic acid (EGTA), tartaric acid, a polycarboxylic acid, a lignosulphonate, hydroxyethylidene diphoshponic acid (HEDP), diethylene triamine penta (methylene phosphonic) acid (DETMP), amino-tri-methylene phosphonic acid (ATMP), ethylene diamine tetra (methylene phosphonic) acid (EDTMP), any salts thereof, and any combinations thereof;
a clay weighting agent present in the range of about 0.01% to about 85% by weight of the spacer fluid; and,
a viscosifying agent present in the range of about 1% to about 10% by weight of the spacer fluid;
wherein the spacer fluid is not settable.

22. The spacer fluid of claim 21 wherein diatomaceous earth is present in the range of about 5% to about 20% by weight of the spacer fluid.

23. The spacer fluid of claim 21 wherein the chelating agent is present in the range of about 0.1% to about 0.3% by weight of the spacer fluid.

24. The spacer fluid of claim 21 wherein the base liquid comprises at least one fluid selected from the group consisting of: an aqueous-based fluid, an oil based fluid, a synthetic fluid, and an emulsion.

25. The spacer fluid of claim 21 wherein the vitrified shale is present in the range of about 0.01% to about 90% by weight of the spacer fluid.

26. The spacer fluid of claim 21 further comprising a synthetic inorganic magnesium silicate.

27. The spacer fluid of claim 26 wherein the synthetic inorganic magnesium silicate is present in the range of about 0.1% to about 2.0% by weight of the spacer fluid.

28. The spacer fluid of claim 21 further comprising an inorganic viscosifier.

29. The spacer fluid of claim 28 wherein the inorganic viscosifier is present in the range of about 0.01% to about 0.50% by weight of the spacer fluid.

30. The spacer fluid of claim 21 further comprising a fluid loss control agent.

31. The spacer fluid of claim 21 wherein the spacer fluid has a 300/3 ratio between about 2.0 and about 5.0.

32. The spacer fluid of claim 21 wherein the spacer fluid has a 300/3 ratio of about 1.0.
